(19) United States
(12) Patent Application Publication
(10) Pub. No.: US 2024/0388216 A1
(43) Pub. Date: Nov. 21, 2024

(54) POWER CONVERSION SYSTEM AND PROGRAM

(71) Applicant: DENSO CORPORATION, Kariya-city (JP)

(72) Inventor: Atsuyuki Hiruma, Kariya-city (JP)

(73) Assignee: DENSO CORPORATION, Kariya-city (JP)

(21) Appl. No.: 18/660,446

(22) Filed: May 10, 2024

(30) Foreign Application Priority Data
May 15, 2023 (JP) 2023-079948

(51) Int. Cl. H02M 7/12; H02H 7/122

(52) U.S. Cl. CPC H02M 7/125; H02H 7/122

(57) ABSTRACT

In a power conversion system, a diode is provided to interrupt a flow of current in a prescribed direction from a positive electrode side of a direct-current power supply toward a negative electrode side thereof in a closed circuit including the direct-current power supply, a high-potential-side path, a low-potential-side path, and a smoothing capacitor. A short-circuit switch includes first and second terminals thereof and interrupts a flow of current from a second terminal thereof to a first terminal thereof in response to the short-circuit switch being turned off. The first terminal of the short-circuit switch is connected to an anode of the diode, and the second terminal thereof is connected to a cathode thereof. A voltage detection circuit detects a voltage between the anode and the cathode of the diode. A control apparatus turns the short-circuit switch on or off based on a detection value of the voltage detection circuit.

### CROSS-REFERENCE TO RELATED APPLICATIONS

This application is based on and claims the benefit of priority from Japanese Patent Application No. 2023-079948, filed on May 15, 2023. The entire disclosure of the above application is incorporated herein by reference.

### BACKGROUND

The present disclosure relates to a power conversion system and a program. As this type of system, a system that includes a high-potential-side path, a low-potential-side path, an inverter, and a smoothing capacitor is known. The high-potential-side path is an electrical path connected to a positive electrode side of a direct-current power supply. The low-potential-side path is an electrical path connected to a negative electrode side of the direct-current power supply. The smoothing capacitor connects the high-potential-side path and the low-potential-side path.

### SUMMARY

One aspect embodiment of the present disclosure provides a power conversion system. The power conversion system includes a high-potential-side path, a low-potential-side path, an inverter, a smoothing capacitor, a diode and a short-circuit switch, a voltage detection circuit, and a control apparatus. The high-potential-side path is an electrical path connected to a positive electrode side of a direct-current power supply. The low-potential-side path is an electrical path connected to a negative electrode side of the direct-current power supply. The inverter includes a high-potential-side terminal and a low-potential-side terminal connected to the low-potential-side path. The smoothing capacitor connects the high-potential-side path and the low-potential-side path. The diode and the short-circuit switch are provided on the low-potential-side path or the high-potential-side path. The diode is provided to interrupt a flow of current in a prescribed direction from the positive electrode side of the direct-current power supply toward the negative electrode side of the direct-current power supply through the direct-current power supply, in a closed circuit including the direct-current power supply, the high-potential-side path, the low-potential-side path, and the smoothing capacitor. The short-circuit switch includes a first terminal and a second terminal, and permits a flow of current between the first terminal and the second terminal when the short-circuit switch is turned on, and interrupts a flow of current from the second terminal to the first terminal when the short-circuit switch is turned off. The first terminal of the short-circuit switch is connected to an anode of the diode. The second terminal of the short-circuit switch is connected to a cathode of the diode. The voltage detection circuit detects a voltage between the anode and the cathode of the diode. The control apparatus turns the short-circuit switch on or off based on a detection value of the voltage detection circuit.

### BRIEF DESCRIPTION OF THE DRAWINGS

In the accompanying drawings:

FIG. 1 is an overall configuration diagram illustrating a power conversion system according to a first embodiment;

FIG. 2 is a diagram illustrating a voltage detection circuit;

FIG. 3 is a diagram illustrating frequency characteristics of a ripple voltage of a smoothing capacitor, a current flowing through the smoothing capacitor, and a voltage across a diode;

FIG. 4 is a flowchart illustrating the steps in a control process of a short-circuit switch;

FIG. 5 is a diagram illustrating a voltage detection circuit according to a second embodiment;

FIG. 6 is a flowchart illustrating the steps in a control process of a short-circuit switch;

FIG. 7 is a diagram illustrating a voltage detection circuit according to a third embodiment;

FIG. 8 is a flowchart illustrating the steps in a control process of a short-circuit switch;

FIG. 9 is a diagram illustrating a voltage detection circuit according to a fourth embodiment;

FIG. 10 is a flowchart illustrating the steps in a short-circuit failure determination process of a short-circuit switch according to a fifth embodiment;

FIG. 11 is a flowchart illustrating the steps in a control process of a short-circuit switch during regenerative drive control according to a sixth embodiment;

FIG. 12 is an overall configuration diagram illustrating a power conversion system according to another embodiment; and;

FIG. 13 is a flowchart illustrating the steps in a control process of a short-circuit switch according to another embodiment.

### DESCRIPTION OF THE EMBODIMENTS

A system that includes a high-potential-side path, a low-potential-side path, an inverter, and a smoothing capacitor is known. The high-potential-side path is an electrical path connected to a positive electrode side of a direct-current power supply. The low-potential-side path is an electrical path connected to a negative electrode side of the direct-current power supply. The smoothing capacitor connects the high-potential-side path and the low-potential-side path.

Due to the smoothing capacitor being charged and discharged by switching control of the inverter, harmonic currents flow through the high-potential-side path and the low-potential-side path. Voltage variations occur between the high-potential-side path and the low-potential-side path when the harmonic currents flow. If a frequency of the voltage variation becomes close to a resonant frequency of an inductor-capacitor (LC) filter including the smoothing capacitor, a current flowing through the smoothing capacitor increases as a result of resonance in the LC filter. In this case, reliability of constituent components of the LC filter may decrease.

Therefore, techniques for suppressing the voltage variations are known. A technique described in German Patent Application Publication No. 102020215777 can be given as an example of such a technique. A power conversion system includes a diode to suppress the voltage variations. The diode is provided to interrupt a flow of current in a prescribed direction from a positive electrode side of a direct-current power supply to a negative electrode side of the direct-current power supply through the direct-current power supply, in a closed circuit including the direct-current power supply, a high-potential-side path, a low-potential-side path, and a smoothing capacitor.

To reduce loss in the power conversion system while suppressing voltage variations, the power conversion system includes a short-circuit switch, a ripple voltage detection circuit and a control apparatus. The short-circuit switch is provided to short-circuit between an anode and a cathode of the diode. The ripple voltage detection circuit detects a high-frequency ripple voltage applied to both ends of the smoothing capacitor.

The control apparatus turns the short-circuit switch on or off based on the detected ripple voltage. Specifically, when determined that the ripple voltage exceeds a threshold value, the control apparatus determines that the frequency of the voltage variation is a frequency close to the resonant frequency of the LC filter and transitions to a resonance suppression mode in which the short-circuit switch is turned off. In this case, the voltage variations are suppressed by the diode, and the current flowing through the smoothing capacitor is suppressed. Meanwhile, when determined that the ripple voltage is below the threshold value, the control apparatus determines that the frequency of the voltage variation is not a frequency close to the resonant frequency and transitions to a low-loss mode in which the short-circuit switch is turned on.

The effect of suppressing the current flowing through the smoothing capacitor in the resonance suppression mode is achieved even in a frequency region far from the resonant frequency of the LC filter. Here, the ripple voltage tends to decrease as the frequency of the ripple voltage becomes farther from the resonant frequency. Therefore, in a frequency region in which the frequency of the ripple voltage is far from the resonant frequency, accuracy of determination regarding whether a state is such that either of the low-loss mode and the resonance suppression mode should be switched to the other may decrease.

It is thus desired to provide a power conversion system and a program capable of improving accuracy of determination regarding whether a state is such that either of a low-loss mode and a resonance suppression mode should be switched to the other.

One exemplary embodiment of the present disclosure provides a power conversion system that includes: a high-potential-side path that is an electrical path connected to a positive electrode side of a direct-current power supply; a low-potential-side path that is an electrical path connected to a negative electrode side of the direct-current power supply; an inverter that includes a high-potential-side terminal connected to the high-potential-side path and a low-potential-side terminal connected to the low-potential-side path; a smoothing capacitor that connects the high-potential-side path and the low-potential-side path; a diode and a short-circuit switch that are provided on the low-potential-side path or the high-potential-side path. The diode is provided to interrupt a flow of current in a prescribed direction from the positive electrode side of the direct-current power supply toward the negative electrode side of the direct-current power supply through the direct-current power supply, in a closed circuit including the direct-current power supply, the high-potential-side path, the low-potential-side path, and the smoothing capacitor. The short-circuit switch includes a first terminal and a second terminal, and permits a flow of current between the first terminal and the second terminal when the short-circuit switch is turned on, and interrupts a flow of current from the second terminal to the first terminal when the short-circuit switch is turned off. The first terminal of the short-circuit switch is connected to an anode of the diode. The second terminal of the short-circuit switch is connected to a cathode of the diode. The power conversion system also includes: a voltage detection circuit that detects a voltage between the anode and the cathode of the diode; and a control apparatus that turns the short-circuit switch on or off based on a detection value of the voltage detection circuit.

The voltage between the anode and the cathode of the diode is greater when the diode is in a non-conductive state and a flow of current is interrupted than when the diode is in a conductive state and a forward current is flowing. Therefore, the voltage between the anode and the cathode of the diode is a parameter that enables ascertainment of whether a state is such that either of a low-loss mode in which the short-circuit switch is turned on and a resonance suppression mode in which the short-circuit switch is turned off should be switched to the other.

Therefore, in this exemplary embodiment of the present disclosure, the voltage detection circuit detects the voltage between the anode and the cathode of the diode and the control apparatus turns the short-circuit switch on and off based on the detection value of the voltage detection circuit. As a result, even if a frequency of a ripple voltage is far from a resonant frequency, accuracy of determination of whether the state is such that either of the low-loss mode in which the short-circuit switch is turned on and the resonance suppression mode in which the short-circuit switch is turned off should be switched to the other can be improved.

A plurality of embodiments will be described with reference to the drawings. According to the plurality of embodiments, sections that are functionally and/or structurally corresponding and/or related may be given the same reference numbers or reference numbers of which digits in the hundreds place and higher differ. Descriptions according to other embodiments can be referenced regarding the corresponding sections and/or related sections.

### First Embodiment

A first embodiment actualizing the power conversion system of the present disclosure will be described below with reference to the drawings. The system according to the present embodiment is mounted in a vehicle such as an electric vehicle or a hybrid vehicle.

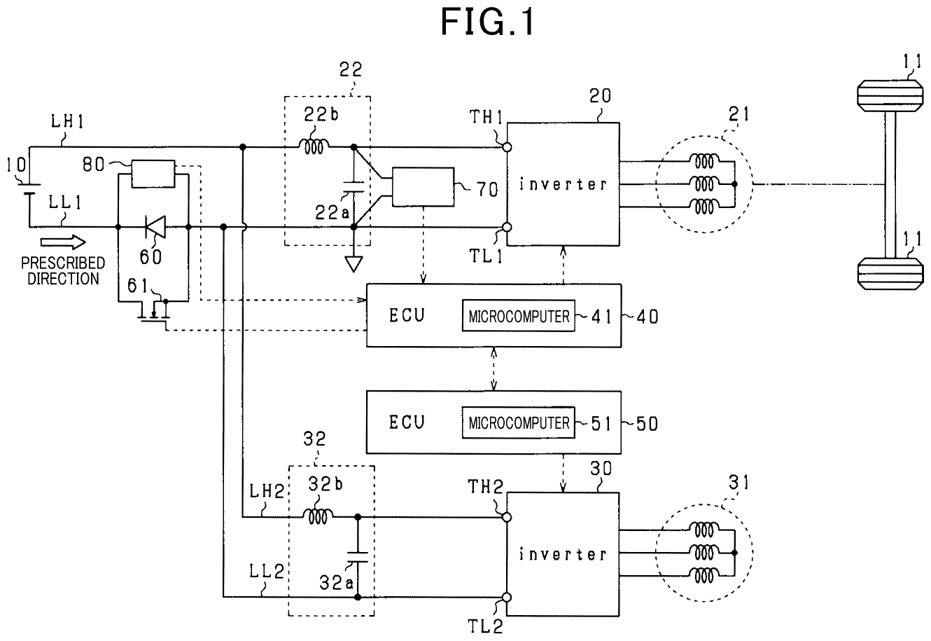

As shown in FIG. 1, the system includes a storage battery 10, a first inverter 20, and a second inverter 30. The storage battery 10 is a secondary battery that can be charged and discharged and may be, for example, a lithium-ion storage battery or a nickel-hydrogen storage battery.

The first inverter 20 and the second inverter 30 are three-phase inverters each including a series connection body of upper and lower arm switches for the three phases. The upper and lower arm switches may be, for example, N-channel metal-oxide-semiconductor field-effect transistors (MOSFETs) or insulated-gate bipolar transistors (IGBTs). If the switch is a MOSFET, a high-potential-side terminal of the switch is a drain and a low-potential-side terminal is a source. If the switch is an IGBT, the high-potential-side terminal is a collector and the low-potential side terminal is an emitter.

The first inverter 20 includes a first high-potential-side terminal TH1 and a first low-potential-side terminal TL1. The high-potential-side terminal of the upper arm switch of each phase is connected to the first high-potential-side terminal TH1. The low-potential-side terminal of the lower arm switch of each phase is connected to the first low-potential-side terminal TL1

The second inverter 30 includes a second high-potential-side terminal TH2 and a second low-potential-side terminal TL2. The high-potential-side terminal of the upper arm switch of each phase is connected to the second high-potential-side terminal TH2. The low-potential-side terminal of the lower arm switch of each phase is connected to the second low-potential-side terminal TL2

The first inverter 20 and the second inverter 30 are connected in parallel to the storage battery 10. A first end of a first high-potential-side path LH1 that is an electrical path is connected to a positive electrode terminal of the storage battery 10. The first high-potential-side terminal TH1 of the first inverter 20 is connected to a second end of the first high-potential-side path LH1. A first end of a first low-potential-side path LL1 that is an electrical path is connected to a negative electrode terminal of the storage battery 10. The first low-potential-side terminal TL1 of the first inverter 20 is connected to a second end of the first low-potential-side path LL1.

A first end of a second high-potential-side path LH2 that is an electrical path is connected to an intermediate portion of the first high-potential-side path LH1. The second high-potential-side terminal TH2 of the second inverter 30 is connected to a second end of the second high-potential-side path LH2. A first end of a second low-potential-side path LL2 that is an electrical path is connected to an intermediate portion of the first low-potential-side path LL1. The second low-potential-side terminal TL2 of the second inverter 30 is connected to a second end of the second low-potential-side path LL2.

The system includes a first rotating electric machine 21 and a second rotating electric machine 31. The first rotating electric machine 21 and the second rotating electric machine 31 are three-phase rotating electric machines and may be, for example, synchronous motors. The first rotating electric machine 21 and the second rotating electric machine 31 each include armature windings for three phases. The first inverter 20 is electrically connected to the armature windings of the first rotating electric machine 21, and the second inverter 30 is electrically connected to the armature windings of the second rotating electric machine 31. The first rotating electric machine 21 is an onboard main machine and serves as a traveling power source for the vehicle. Therefore, a rotor of the first rotating electric machine 21 is capable of transmitting power to and from a drive wheel 11 of the vehicle. The second rotating electric machine 31 drives an onboard auxiliary machine. The onboard auxiliary machine may be, for example, an electric compressor configuring an onboard air conditioning apparatus or a blower fan configuring the onboard air conditioning apparatus.

The system includes a first filter 22 and a second filter 32. The first filter 22 and the second filter 32 are LC filters. The first filter 22 is provided further toward the first inverter 20 side than connecting portions with the second high- and low-potential-side paths LH2 and LL2 on the first high- and low-potential-side paths LH1 and LL1. The second filter 32 is provided on the second high- and low-potential-side paths LH2 and LL2.

The first filter 22 includes a first smoothing capacitor 22a serving as a passive element and a first inductor 22b. The first smoothing capacitor 22a may be, for example, a film capacitor. The first smoothing capacitor 22a connects the first high-potential-side path LH1 and the first low-potential-side path LL1. The first inductor 22b may be an inductor serving as a passive element or a wiring inductor on the first high-potential-side path LH1.

The second filter 32 includes a second smoothing capacitor 32a serving as a passive element and a second inductor 32b. The second smoothing capacitor 32a may be, for example, a film capacitor. The second smoothing capacitor 32a connects the second high potential path LH2 and the second low potential path LL2. The second inductor 32b may be an inductor serving as a passive element or a wiring inductor on the second high-potential-side path LH2

The system includes a diode 60 and a short-circuit switch 61. The diode 60 is a passive element and is provided further toward the storage battery 10 side than a connecting portion with the second low-potential-side path LL2 on the first low-potential-side path LL1. A cathode of the diode 60 is connected to a negative electrode side of the storage battery 10. As a result, the diode 60 is provided to interrupt a flow of current in a prescribed direction from a positive electrode side of the storage battery 10 toward the negative electrode side through the inside of the storage battery 10, in a first closed circuit including the storage battery 10, a portion of the first high-potential-side path LH1, the first smoothing capacitor 22a, and a portion of the first low-potential-side path LL1.

The short-circuit switch 61 is a switch for switching a control mode of the system to a resonance suppression mode or a low-loss mode, described hereafter, and is connected in parallel to the diode 60. The short-circuit switch 61 according to the present embodiment is an N-channel MOSFET. The short-circuit switch 61 includes a source that is a first terminal, a drain that is a second terminal, and a gate. The source of the short-circuit switch 61 is connected to an anode of the diode 60. The drain of the short-circuit switch 61 is connected to a cathode of the diode 60.

When the short-circuit switch 61 is turned on, a flow of current between the source and the drain is permitted, and the control mode is set to the low-loss mode. Meanwhile, when the short-circuit switch 61 is turned off, the flow of current from the drain to the source is interrupted, and the control mode is set to the resonance suppression mode.

The system includes a first control apparatus 40 and a second control apparatus 50. The first control apparatus 40 is an electronic control unit (ECU) mainly configured by a first microcomputer 41 and performs switching control of the first inverter 20. The second control apparatus 50 is an ECU mainly configured by a second microcomputer 51 and performs switching control of the second inverter 30. The first control apparatus 40 and the second control apparatus 50 are capable of communicating with each other.

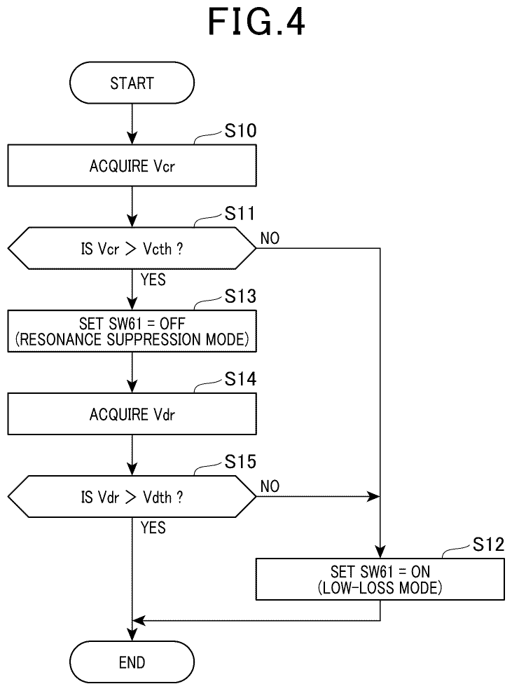

The first microcomputer 41 and the second microcomputer 51 each include a central processing unit (CPU). Functions provided by the first microcomputer 41 and the second microcomputer 51 can be provided by software recorded in a tangible, computer-readable memory apparatus and a computer that runs the software, only software, only hardware, or a combination thereof. For example, when the first microcomputer 41 and the second microcomputer 51 are each provided by an electronic circuit that is hardware, the first microcomputer 41 and the second microcomputer 51 may be provided by a digital circuit including numerous logic circuits or an analog circuit. For example, the first microcomputer 41 and the second microcomputer 51 run programs stored in a non-transitory, tangible, computer-readable storage medium that serves as a storage unit included in the first microcomputer 41 and the second microcomputer 51 itself. The programs may include, for example, a program for processes shown in FIG. 4 and the like, described hereafter. As a result of a set of instructions composing the program being executed, a method corresponding to the program is performed. The storage unit may be, for example, a non-volatile memory. Here, for example, the program stored in the storage unit can be updated over a communication network such as the Internet or over-the-air (OTA).

The first control apparatus 40 performs power running drive control. The power running drive control is switching control of the first inverter 20 for converting direct-current power outputted from the storage battery 10 to alternating-current power and supplying the converted alternating-current power to the armature windings of the first rotating electric machine 21. The first rotating electric machine 21 functions as an electric motor when power running drive control is performed. As a result, the rotor of the first rotating electric machine 21 imparts drive torque to the drive wheel 11, and the vehicle travels.

The first control apparatus 40 performs regenerative drive control. The regenerative drive control is switching control of the first inverter 20 for converting alternating-current power generated by the first rotating electric machine 21 to direct-current power and supplying the converted direct-current power to the storage battery 10. The first rotating electric machine 21 functions as a generator when regenerative drive control is performed.

The second control apparatus 50 performs switching control of the second inverter 30 to convert the direct-current power outputted from the storage battery 10 to alternating-current power and supply the converted alternating-current power to the armature windings of the second rotating electric machine 31. The onboard auxiliary machine is thereby driven.

Here, due to the first smoothing capacitor 22a being charged and discharged by switching control of the first inverter 20, harmonic currents flow through the first high-potential-side path LH1 and the first low-potential-side path LL1. Voltage variations occur between the paths LH1 and LL1 as a result of the harmonic currents flowing. A frequency of the voltage variation may be, for example, twice a single switching frequency of the switches in the first inverter 20.

In a state in which voltage variations between the paths LH1 and LL1 occur, if the frequency of the voltage variation becomes close to a resonant frequency of the first filter 22, a current flowing through the first filter 22 increases. In this case, an effective value of the current flowing through the first smoothing capacitor 22a may exceed a rated current of the first smoothing capacitor 22a, or an effective value of the current flowing through the first inductor 22b may exceed a rated current of the first inductor 22b, and reliability of the first smoothing capacitor 22a and the first inductor 22b may decrease as a result. As a result of switching control of the second inverter 30 as well, harmonic currents similarly flow through the second high-potential-side path LH2 and the second low-potential-side path LL2, and voltage variations occur between the paths LH2 and LL2.

The issue attributed to the voltage variation is marked in a configuration in which the plurality of inverters 20 and 30 are connected in parallel to the common storage battery 10.

The diode 60 is provided to address this issue. As a result, the harmonic current flowing through the first closed circuit can be reduced. In addition, in a second closed circuit including the storage battery 10, a portion of the first high-potential-side path LH1, a portion of the second high-potential-side path LH2, the second smoothing capacitor 32a, a portion of the second low-potential-side path LL2, and a portion of the first low-potential-side path LL1, the harmonic current flowing through this closed circuit can be reduced.

The first control apparatus 40 includes a capacitor voltage detection circuit 70 (corresponding to a “second voltage detection circuit”) and a diode voltage detection circuit 80 (corresponding to a “first voltage detection circuit”) as a configuration for switching the control mode to the resonance suppression mode or the low-loss mode.

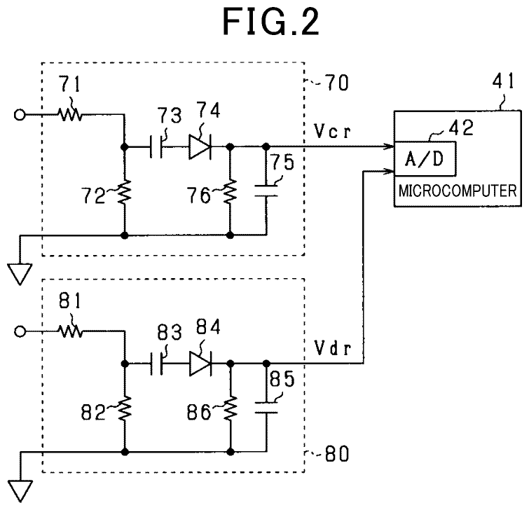

The capacitor voltage detection circuit 70 and the diode voltage detection circuit 80 will be described with reference to FIG. 2.

The capacitor voltage detection circuit 70 detects an equivalent amount to an effective value of a terminal voltage of the first smoothing capacitor 22a. The terminal voltage includes a ripple voltage. The ripple voltage is an alternating-current component included in the terminal voltage of the first smoothing capacitor 22a. The capacitor voltage detection circuit 70 includes a first voltage divider resistor 71 and a second voltage divider resistor 72. A high-potential-side terminal of the first smoothing capacitor 22a is connected to a first end of the first voltage divider resistor 71. A first end of the second voltage divider resistor 72 is connected to a second end of the voltage divider resistor 71. A low-potential-side terminal of the first smoothing capacitor 22a is connected to a second end of the second voltage divider resistor 72. That is, a series connection body of the first voltage divider resistor 71 and the second voltage divider resistor 72 is connected in parallel to the first smoothing capacitor 22a.

The capacitor voltage detection circuit 70 includes a first capacitor 73, a rectifier diode 74, a second capacitor 75, and a resistor 76. A connection point between the first voltage divider resistor 71 and the second voltage divider resistor 72 is connected to a first end of the first capacitor 73. The first capacitor 73 and the second voltage divider resistor 72 configure a high-pass filter circuit that cuts direct-current components of voltages divided by the voltage divider resistors 71 and 72.

An anode of the rectifier diode 74 is connected to a second end of the first capacitor 73. A first end of the second capacitor 75 and a first end of the resistor 76 are connected to a cathode of the rectifier diode 74. The low-potential-side terminal of the first smoothing capacitor 22a is connected to a second end of the second capacitor 75 and a second end of the resistor 76. The rectifier diode 74 rectifies the voltage from which the direct-current component is cut, and the second capacitor 75 smooths the rectified voltage. Through adjustment of a time constant determined from a capacitance of the second capacitor 75 and a resistance value of the resistor 76, a terminal voltage of the second capacitor 75 becomes the equivalent amount to the effective value of the terminal voltage of the first smoothing capacitor 22a. The terminal voltage of the second capacitor 75 is inputted to an analog-to-digital (AD) converter 42 included in the first microcomputer 41.

The diode voltage detection circuit 80 detects an equivalent amount of an effective value of a voltage between the anode and the cathode of the diode 60. The diode voltage detection circuit 80 according to the present embodiment has a configuration similar to that of the capacitor voltage detection circuit 70. The diode voltage detection circuit 80 includes a first voltage divider resistor 81, a second voltage divider resistor 82, a first capacitor 83, a rectifier diode 84, a second capacitor 85, and a resistor 86. The cathode of the diode 60 is connected to a first end of the first voltage divider resistor 81. A first end of the second voltage divider resistor 82 is connected to a second end of the first voltage divider resistor 81. The anode of the diode 60 is connected to a second end of the second voltage divider resistor 82. That is, a series connection body of the first voltage divider resistor 81 and the second voltage divider resistor 82 are connected in parallel to the diode 60.

Through adjustment of a time constant determined from a capacitance of the second capacitor 85 and a resistance value of the resistor 86, a terminal voltage of the second capacitor 85 becomes the equivalent amount to the effective value of the voltage between the cathode and the anode of the diode 60. The terminal voltage of the second capacitor 85 is inputted to the AD converter 42.

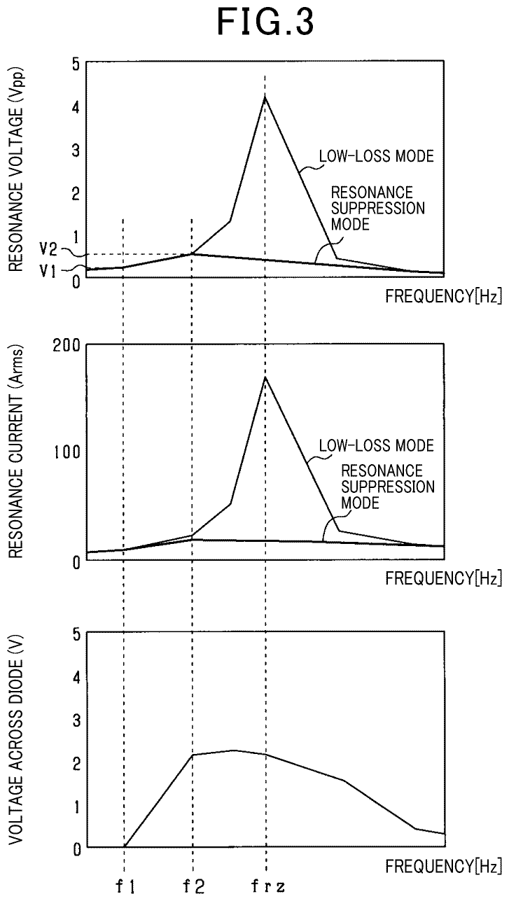

FIG. 3 shows calculation results of frequency characteristics of a voltage variation amount Vpp of the first smoothing capacitor 22a, a current effective value of the current flowing through the first smoothing capacitor 22a, and a voltage across the diode 60 when a sweep of the frequencies of the voltage variations generated between the paths LH1 and LL1 is performed. The voltage variation amount Vpp is a peak-to-peak value. The voltage across the diode 60 is a value obtained when the diode 60 is in a non-conducting state. The frequency characteristics of a case in which the low-loss mode is performed and a case in which the resonance suppression mode is performed are shown.

The voltage variation amount and the current effective value decrease as the frequency becomes farther from a resonant frequency frz of the first filter 22. Here, the description will be given with focus on first and second frequencies f1 and f2 (f2>f1) that are in a frequency region lower than the resonant frequency frz and in which an amount of change in the voltage variation amount and an amount of change in the current effective value per unit frequency change amount are small.

In the example shown in FIG. 3, in the low-loss mode, the first filter 22 is slightly resonant at the first frequency f1. Therefore, a first voltage value V1 (such as 0.26 V) is detected as the voltage variation amount Vpp of the first smoothing capacitor 22a. In the low-loss mode, a degree of resonance is greater at the second frequency f2 than at the first frequency f1, and a second voltage value V2 (such as 0.65 V) greater than the first voltage value V1 is detected as the voltage variation amount Vpp of the first smoothing capacitor 22a.

At the first frequency f1, even if the low-loss mode is switched to the resonance suppression mode, the current effective value of the current flowing through the first smoothing capacitor 22a can only be slightly reduced (for example, a few %). In contrast, at the second frequency f2, when the low-loss mode is switched to the resonance suppression mode, the current effective value of the current flowing through the first smoothing capacitor 22a can be more reduced (for example, 20%) than at the first frequency f1. Therefore, a capacitor voltage threshold Vcth that is a switching threshold for switching from either of the low-loss mode and the resonance suppression mode to the other is preferably set to a value between the first voltage value V1 and the second voltage value V2.

However, the voltage variation amount Vpp of the first smoothing capacitor 22a is small in a frequency region from the first frequency f1 to the second frequency f2. Due to the voltage variation amount Vpp being small and, for example, temperature dependence of the voltage detection value attributed to temperature characteristics of the capacitor voltage detection circuit 70, accuracy of determination regarding whether a state is such that either of the low-loss mode and the resonance suppression mode should be switched to the other may decrease.

To address this issue, according to the present embodiment, a voltage detection value of the diode voltage detection circuit 80 is used in the determination of the mode switching state. The voltage between the anode and the cathode of the diode 60 is greater when the diode 60 is in a non-conductive state and the flow of current is interrupted than when the diode 60 is in a conductive state and a forward current is flowing. In the example shown in FIG. 3, in the frequency range from the first frequency f1 to the second frequency f2, the amount of change in the terminal voltage of the diode 60 per unit frequency change amount tends to be greater than the amount of change in the voltage variation amount Vpp of the first smoothing capacitor 22a per unit frequency change amount. Therefore, the voltage detection value of the diode voltage detection circuit 80 is suitable as a parameter for ascertaining whether the state is such that either of the low-loss mode in which the short-circuit switch 61 is turned on and the resonance suppression mode in which the short-circuit switch 61 is turned off should be switched to the other.

FIG. 4 shows a flowchart of a control process of the short-circuit switch 61 performed by the first control apparatus 40. This process is repeatedly performed, for example, at a predetermined control cycle.

At step S10, the first control apparatus 40 acquires, through the AD converter 42, a capacitor voltage detection value Vcr that is a terminal voltage of the second capacitor 75 configuring the capacitor voltage detection circuit 70.

At step S11, the first control apparatus 40 determines whether the acquired capacitor voltage detection value Vcr exceeds a capacitor voltage threshold value Vcth (corresponding to a “second threshold value”).

When determined at step S11 that the capacitor voltage detection value Vcr is equal to or less than the capacitor voltage threshold value Vcth, the first control apparatus 40 proceeds to step S12 and performs the low-loss mode in which the short-circuit switch 61 is turned on.

Meanwhile, when determined that the capacitor voltage detection value Vcr exceeds the capacitor voltage threshold value Vcth, the first control apparatus 40 proceeds to step S13 and performs the resonance suppression mode in which the short-circuit switch 61 is turned off.

At step S14, the first control apparatus 40 acquires, through the AD converter 42, a diode voltage detection value Vdr that is the terminal voltage of the second capacitor 85 configuring the diode voltage detection circuit 80.

At step S15, the first control apparatus 40 determines whether the acquired diode voltage detection value Vdr exceeds a diode voltage threshold value Vdth (corresponding to a “first threshold value”).

When determined that the diode voltage detection value Vdr is equal to or less than the diode voltage threshold value Vdth, the first control apparatus 40 proceeds to step S12, cancels the resonance suppression mode, and performs the low-loss mode.

Meanwhile, when determined that the diode voltage detection value Vdr exceeds the diode voltage threshold value Vdth, or upon completion of the process at step S12, the first control apparatus 40 proceeds to step S10 in the next control cycle.

As described in detail above, according to the present embodiment, the diode voltage detection value Vdr is used to determine whether the state is such that either of the low-loss mode and the resonance suppression mode should be switched to the other. As a result, even if the frequency of the ripple voltage applied to both ends of the first smoothing capacitor 22a is far from the resonant frequency frz, the accuracy of the determination of the mode switching state can be improved. Consequently, transition to the resonance suppression mode can be suppressed from not being performed regardless of the state being such that the current flowing to the first smoothing capacitor 22a increases, or transition to the low-loss mode can be suppressed from not being performed regardless of the current flowing to the first smoothing capacitor 22a being small.

The first control apparatus 40 acquires the value of the equivalent amount to the effective value of the voltage between the anode and the cathode of the diode 60 as the diode voltage detection value Vdr. The equivalent amount to the effective value of the diode 60 basically exceeds the diode voltage threshold value Vdth in a state in which the control mode should be set to the resonance suppression mode. Therefore, the short-circuit switch 61 can be suppressed from being frequently turned on and off at the frequencies of the voltage variations in the paths LH1 and LL1. As a result, switching loss in the power conversion system can be reduced and generation of noise can be suppressed.

The accuracy of the determination of the mode switching state can be improved through use of the condition at step S11 in addition to the condition at step S15 in FIG. 4

### Variation Examples According to the First Embodiment

In the processes in FIG. 4, the processes at steps S10 and S11 may be omitted.

The capacitor voltage detection circuit 70 may be configured to detect an equivalent amount to an amplitude of the ripple voltage applied to both ends of the first smoothing capacitor 22a. This configuration can be obtained, for example, by a circuit configuration in which the resistor 76 is omitted from the capacitor voltage detection circuit 70 shown in FIG. 2.

In addition, the diode voltage detection circuit 80 may be configured to detect an equivalent amount to an amplitude of the voltage between the anode and the cathode of the diode 60. This configuration can be obtained, for example, by a circuit configuration in which the resistor 86 is removed from the diode voltage detection circuit 80 shown in FIG. 2.

### Second Embodiment

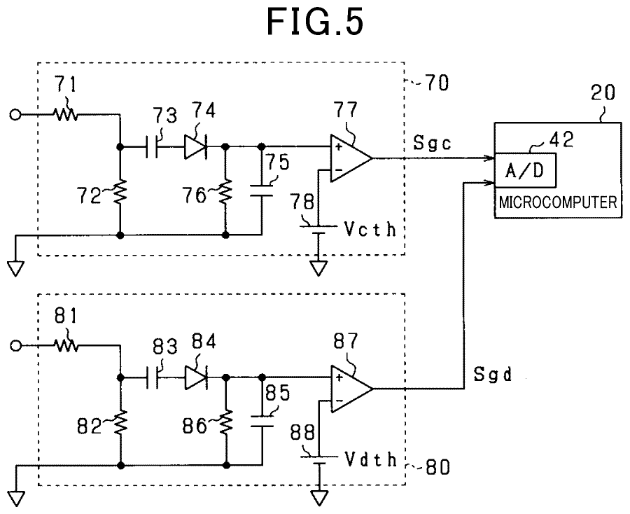

A second embodiment will be described below with reference to the drawings, mainly focusing on the differences from the first embodiment. According to the present embodiment, as shown in FIG. 5, the configurations of the capacitor voltage detection circuit 70 and the diode voltage detection circuit 80 are modified.

The capacitor voltage detection circuit 70 includes a comparator 77 and a reference power supply 78. The terminal voltage of the second capacitor 75 is input to a non-inverting input terminal of the comparator 77. A direct-current voltage of the reference power supply 78 is input to an inverting input terminal of the comparator 77. The direct-current voltage of the reference power supply 78 is the capacitor voltage threshold Vcth. An output signal Sgc of the comparator 77 is inputted to the AD converter 42.

When the terminal voltage of the second capacitor 75 exceeds the capacitor voltage threshold value Vcth, the output signal Sgc of the comparator 77 becomes H. Meanwhile, when the terminal voltage of the second capacitor 75 falls below the capacitor voltage threshold value Vcth, the output signal Sgc of the comparator 77 becomes L.

The diode voltage detection circuit 80 includes a comparator 87 and a reference power supply 88. The terminal voltage of the second capacitor 85 is input to a non-inverting input terminal of the comparator 87. A direct-current voltage of the reference power supply 88 is input to an inverting input terminal of the comparator 87. The direct-current voltage of the reference power supply 88 is the diode voltage threshold value Vdth. An output signal Sgd of the comparator 87 is inputted to the AD converter 42.

When the terminal voltage of the second capacitor 85 exceeds the diode voltage threshold value Vdth, the output signal Sgd of the comparator 87 becomes H. Meanwhile, when the terminal voltage of the second capacitor 85 falls below the diode voltage threshold value Vdth, the output signal Sgd of the comparator 87 becomes L.

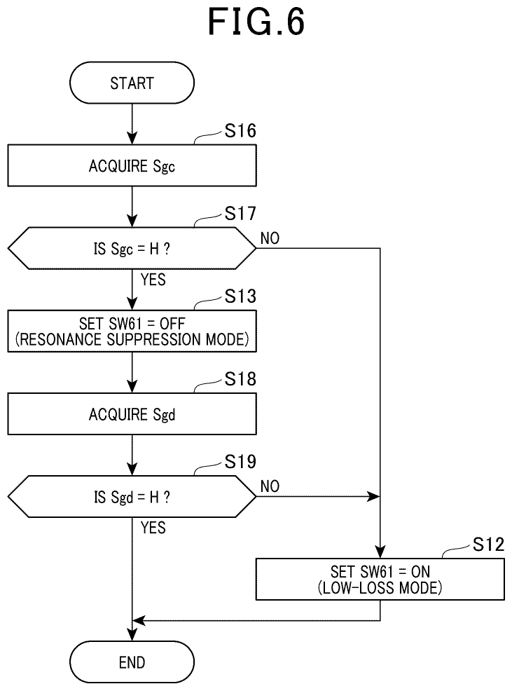

FIG. 6 shows a flowchart of the control process of the short-circuit switch 61 performed by the first control apparatus 40. This process is repeatedly performed, for example, at a predetermined control cycle.

At step S16, the first control apparatus 40 acquires the output signal Sgc of the comparator 77 configuring the capacitor voltage detection circuit 70.

At step S17, the first control apparatus 40 determined whether the logic level of the acquired output signal Sgc is H. When determined that the logic level is L, the first control apparatus 40 proceeds to step S12. When determined that the logic level is H, the first control apparatus 40 proceeds to step S13.

At step S18, the first control apparatus 40 acquires the output signal Sgd of the comparator 87 configuring the diode voltage detection circuit 80.

At step S19, the first control apparatus 40 determines whether the logic level of the acquired output signal Sgd is H. When determined that the logic level is L, the first control apparatus 40 proceeds to step S12.

Meanwhile, when determined YES at step S19 or upon completion of the process at step S12, the first control apparatus 40 proceeds to the process at step S10 in the next control cycle.

The output voltage of the reference power supply 78 configuring the capacitor voltage detection circuit 70 may slightly deviate from an appropriate value for some reason. Even in this case, according to the present embodiment in which the condition at step S19 is provided, the accuracy of the determination of the mode switching state can be improved.

### Variation Examples According to the Second Embodiment

In the processes in FIG. 6, the processes at steps S16 and S17 may be omitted.

### Third Embodiment

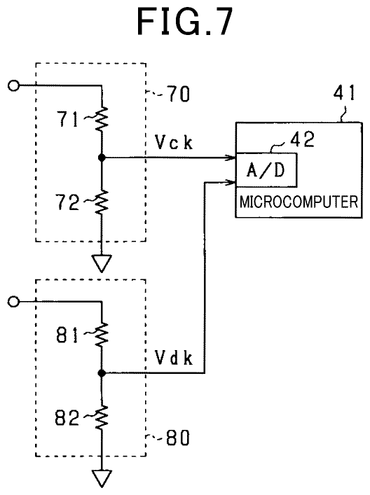

A third embodiment will be described below with reference to the drawings, mainly focusing on the differences from the first embodiment. According to the present embodiment, as shown in FIG. 7, the configurations of the capacitor voltage detection circuit 70 and the diode voltage detection circuit 80 are modified.

The capacitor voltage detection circuit 70 is a resistive voltage divider circuit that includes the first voltage divider resistor 71 and the second voltage divider resistor 72. A terminal voltage of the second voltage divider resistor 72 is inputted to the AD converter 42.

The diode voltage detection circuit 80 is a resistive voltage divider circuit that includes the first voltage divider resistor 81 and the second voltage divider resistor 82. A terminal voltage of the second voltage divider resistor 82 is inputted to the AD converter 42.

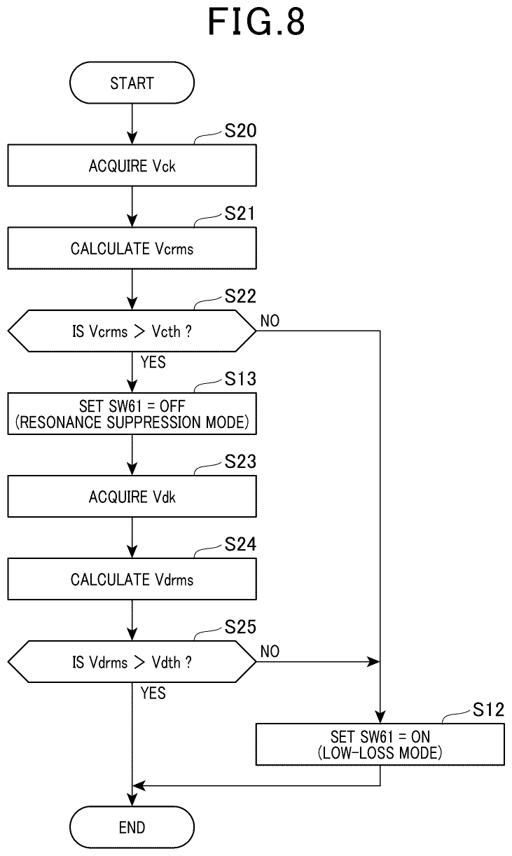

FIG. 8 shows a flowchart of the control process of the short-circuit switch 61 performed by the first control apparatus 40. This process is repeatedly performed, for example, at a predetermined control cycle.

At step S20, the first control apparatus 40 acquires, through the AD converter 42, a terminal voltage Vck of the second voltage divider resistor 72 configuring the capacitor voltage detection circuit 70. The first control apparatus 40 stores the acquired terminal voltage Vck in a memory provided in the first control apparatus 40.

At step S21, the first control apparatus 40 calculates an effective value equivalent amount Vcrms of the ripple voltage applied to both ends of the first smoothing capacitor 22a based on a plurality of terminal voltages Vck that are stored.

At step S22, the first control apparatus 40 determines whether the calculated effective value equivalent amount Vcrms exceeds the capacitor voltage threshold value Vcth. When determined that the effective value equivalent amount Vcrms is equal to or less than the capacitor voltage threshold value Vcth, the first control apparatus 40 proceeds to step S12. Meanwhile, when determined that the effective value equivalent amount Vcrms exceeds the capacitor voltage threshold value Vcth, the first control apparatus 40 proceeds to step S13.

At step S23, the first control apparatus 40 acquires, through the AD converter 42, a terminal voltage Vdk of the second voltage divider resistor 82 configuring the diode voltage detection circuit 80. The first control apparatus 40 stores the acquired terminal voltage Vck in a memory provided in the first control apparatus 40.

At step S24, the first control apparatus 40 calculates an effective value equivalent amount Vdrms of the voltage applied between the anode and the cathode of the diode 60 based on a plurality of terminal voltages Vdk that are stored.

At step S25, the first control apparatus 40 determines whether the calculated effective value equivalent amount Vdrms exceeds the diode voltage threshold value Vdth. When determined that the effective value equivalent amount Vdrms is equal to or less than the diode voltage threshold value Vdth, the first control apparatus 40 proceeds to step S12.

Meanwhile, when determined YES at step S25 or upon completion of the process at step S12, the first control apparatus 40 proceeds to the process at step S10 in the next control cycle.

The accuracy of the determination of the mode switching state can be improved even according to the present embodiment described above.

### Variation Examples According to the Third Embodiment

In the processes in FIG. 8, the processes at steps S20 to S22 may be omitted.

### Fourth Embodiment

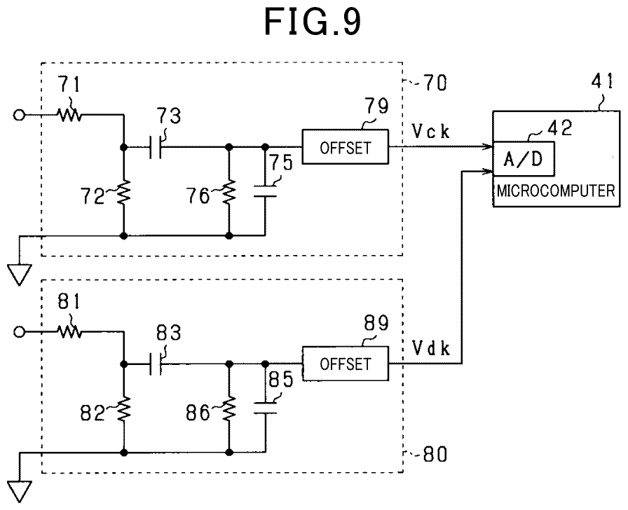

A fourth embodiment will be described below with reference to the drawings, mainly focusing on the differences from the first embodiment. According to the present embodiment, as shown in FIG. 9, the configurations of the capacitor voltage detection circuit 70 and the diode voltage detection circuit 80 are modified.

The capacitor voltage detection circuit 70 includes an offset circuit 79. The offset circuit 79 outputs a voltage value that is the terminal voltage of the second capacitor 75 offset by a first offset amount. The terminal voltage is offset to set the voltage detection value of the capacitor voltage detection circuit 70 within a voltage range that can be input to the AD converter 42.

In a manner similar to the capacitor voltage detection circuit 70, the diode voltage detection circuit 80 includes an offset circuit 89. The offset circuit 89 outputs a voltage value that is the terminal voltage of the second capacitor 85 offset by a second offset amount. The terminal voltage is offset to set the voltage detection value of the diode voltage detection circuit 80 within a voltage range that can be input to the AD converter 42 in a manner similar to that described above.

The voltage values outputted from the offset circuits 79 and 89 are input to the AD converter 42. The first control apparatus 40 performs the processes in FIG. 8 described above. In terms of changes from the processes in FIG. 8, at step S20, the first control apparatus 40 acquires the output voltage value Vck of the offset circuit 79 through the AD converter 42 and stores the output voltage value Vck in the memory. At step S21, the first control apparatus 40 calculates the effective value equivalent amount Vcrms of the ripple voltage applied to both ends of the first smoothing capacitor 22a based on a plurality of voltage values Vck that are stored.

At step S23, the first control apparatus 40 acquires the output voltage value Vdk of the offset circuit 89 through the AD converter 42 and stores the output voltage value Vdk in the memory. At step S24, the first control apparatus 40 calculates the effective value equivalent amount Vdrms of the voltage between the anode and the cathode of the diode 60 based on a plurality of voltage values Vdk that are stored.

The accuracy of the determination of the mode switching state can be improved even according to the present embodiment described above.

### Fifth Embodiment

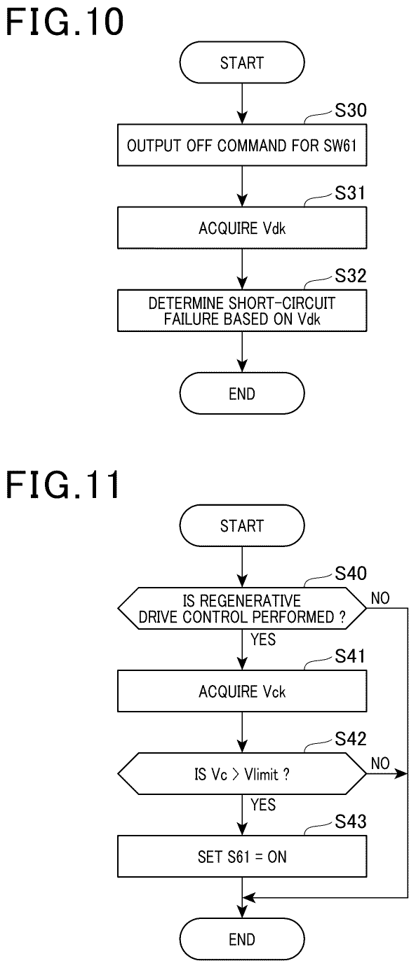

A fifth embodiment will be described below with reference to the drawings, mainly focusing on the differences from the third embodiment. According to the present embodiment, whether a short-circuit failure has occurred in the short-circuit switch 61 is determined based on the detection value of the diode voltage detection circuit 80. FIG. 10 shows the steps in a failure determination process performed by the first control apparatus 40. This process is repeatedly performed, for example, at a predetermined control cycle.

At step S30, the first control apparatus 40 outputs a command to turn off the short-circuit switch 61. Specifically, the first control apparatus 40 outputs a command to set a gate voltage of the short-circuit switch 61 to a value (for example, 0 V) less than a threshold voltage Vth of the short-circuit switch 61.

At step S31, when power is transferred between the storage battery 10 and the second inverter 30 by switching control of the first inverter 20, the first control apparatus 40 acquires, through the AD converter 42, the terminal voltage Vdk of the second voltage divider resistor 82 configuring the diode voltage detection circuit 80.

At step S32, the first control apparatus 40 determines whether a short-circuit failure has occurred in the short-circuit switch 61 based on the acquired terminal voltage Vdk. Specifically, when determined that the terminal voltage Vdk falls below a failure threshold Vfth, the first control apparatus 40 determines that a short-circuit failure has occurred in the short-circuit switch 61. The failure threshold Vfth is a value obtained by the voltage between the anode and the cathode of the diode 60 (specifically, a forward voltage drop Vf) being divided by the voltage divider resistors 81 and 82 when the short-circuit switch 61 is turned off.

According to the present embodiment, whether a short-circuit failure has occurred in the short-circuit switch 61 can be determined based on the detection value of the diode voltage detection circuit 80.

### Sixth Embodiment

A sixth embodiment will be described below with reference to the drawings, mainly focusing on the differences from the first embodiment. According to the present embodiment, in a case in which regenerative drive control is being performed, the short-circuit switch 61 is turned on when the terminal voltage of the first smoothing capacitor 22a becomes excessively high. FIG. 11 shows a flowchart of the control process of the short-circuit switch 61 performed by the first control apparatus 40. This process is repeatedly performed, for example, at a predetermined control cycle.

At step S40, the first control apparatus 40 determines whether regenerative drive control is being performed.

When determined YES at step S40, the first control apparatus 40 proceeds to step S41 and acquires, through the AD converter 42, the terminal voltage Vck of the second voltage divider resistor 72 configuring the capacitor voltage detection circuit 70.

At step 542, the first control apparatus 40 calculates a terminal voltage Vc of the first smoothing capacitor 22a based on the acquired terminal voltage Vck. Then, the first control apparatus 40 determines whether the calculated terminal voltage Vc exceeds an overvoltage threshold Vlimit. The overvoltage threshold Vlimit is set to an upper limit voltage at which reliability of the first smoothing capacitor 22a can be maintained or a value lower than this upper limit voltage.

When determined YES at step S42, the first control apparatus 40 proceeds to step S43 and turns on the short-circuit switch 61.

According to the present embodiment described above, in the case in which regenerative drive control is being performed, the first smoothing capacitor 22a can be suppressed from failing in accompaniment with the resonance suppression mode being performed.

### OTHER EMBODIMENTS

Here, the above-described embodiments may be modified in the following manner.

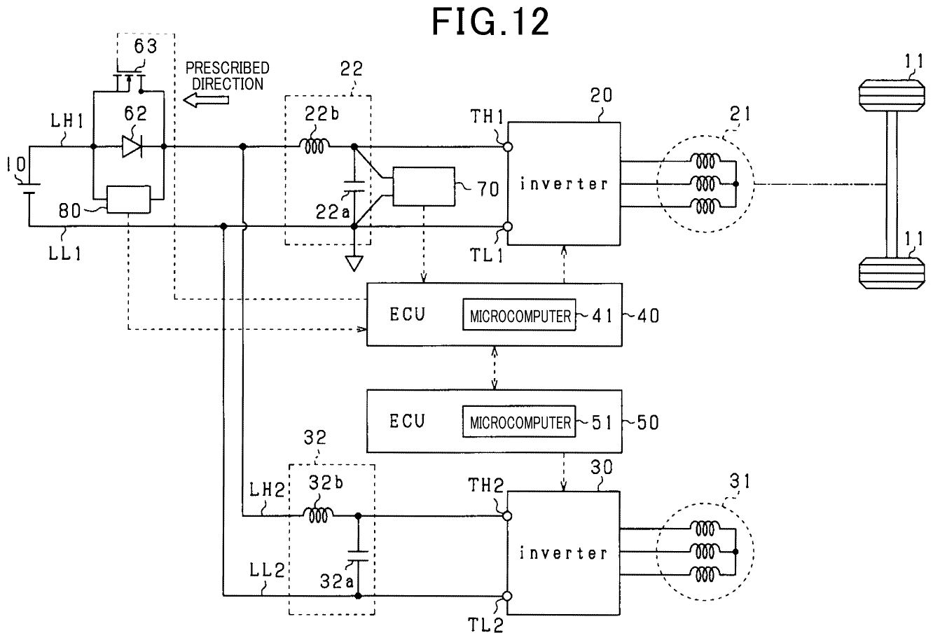

As shown in FIG. 12, a diode 62 and a short-circuit switch 63 may be provided further toward the storage battery 10 side than a connecting portion with the second high-potential path LH2 on the first high-potential-side path LH1. An anode of the diode 62 is connected to the positive electrode side of the storage battery 10.

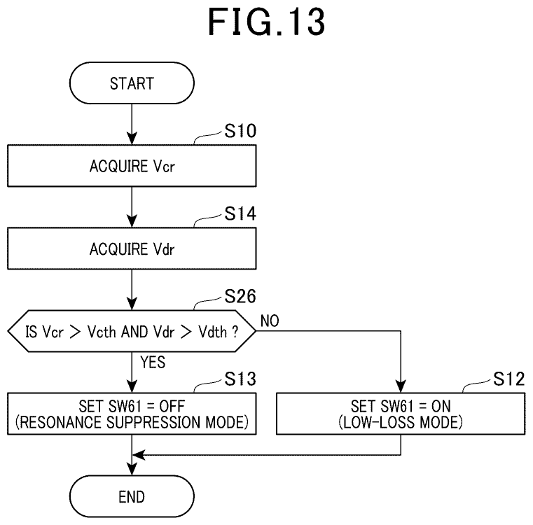

As shown in FIG. 13, the control process of the short-circuit switch 61 performed by the first control apparatus 40 may be modified. After steps S10 and S11, at step S26, the first control apparatus 40 determines whether both a first condition that the capacitor voltage detection value Vcr exceeds the capacitor voltage threshold value Vcth and a second condition that the diode voltage detection value Vdr exceeds the diode voltage threshold value Vdth are met. When determined that both the first and second conditions are met, the first control apparatus 40 proceeds to step S13. When determined that at least one of the first and second conditions is not met, the first control apparatus 40 proceeds to step S12.

The inverter is not limited to two inverters and may be one inverter, or three or more inverters.

The diode 60 (or the diode 62) is not limited to a passive element that is an electronic component and may also be a body diode of the short-circuit switch 61 (or the short-circuit switch 63). In this case, for example, a diode serving as a passive element may not be connected in parallel to the short-circuit switch.

The short-circuit switch is not limited to the N-channel MOSFET and, for example, may be a parallel connection body of a first IGBT and a second IGBT. Specifically, an emitter of the second IGBT is connected to a collector of the first IGBT, and a diode is connected in parallel to the parallel connection body.

The first filter 22 and the second filter 32 are not limited to that having a single-stage configuration composed of a capacitor and an inductor, and may have, for example, a multi-stage configuration or a π-type configuration.

The direct-current power supply is not limited to the storage battery 10 and may include, for example, a large-capacity electric double-layer capacitor or both a storage battery and an electric double-layer capacitor.

A moving body in which a power conversion apparatus is mounted is not limited to a vehicle and may be, for example, an aircraft or a ship. In addition, a mounting destination of the power conversion apparatus is not limited to a moving body. The power conversion apparatus may be a stationary apparatus.

The control apparatus and the method thereof described in the present disclosure may be implemented by a dedicated computer that is provided such as to be configured by a processor and a memory, the processor being programmed to provide one or a plurality of functions that are realized by a computer program. Alternatively, the control apparatus and the method thereof described in the present disclosure may be implemented by a dedicated computer that is provided by a processor being configured by a single dedicated hardware logic circuit or more. Still alternatively, the control apparatus and the method thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible, computer-readable storage medium that can be read by a computer as instructions performed by the computer.

What is claimed is:

1. A power conversion system comprising:
a high-potential-side path that is an electrical path connected to a positive electrode side of a direct-current power supply;
a low-potential-side path that is an electrical path connected to a negative electrode side of the direct-current power supply;
at least one inverter that includes a high-potential-side terminal connected to the high-potential-side path and a low-potential-side terminal connected to the low-potential-side path;
a smoothing capacitor that connects the high-potential-side path and the low-potential-side path;
a diode and a short-circuit switch that are provided on the low-potential-side path or the high-potential-side path, wherein
the diode is provided to interrupt a flow of current in a prescribed direction from the positive electrode side of the direct-current power supply toward the negative electrode side of the direct-current power supply through the direct-current power supply, in a closed circuit including the direct-current power supply, the high-potential-side path, the low-potential-side path, and the smoothing capacitor,
the short-circuit switch includes a first terminal and a second terminal, and permits a flow of current between the first terminal and the second terminal in response to the short-circuit switch being turned on, and interrupts a flow of current from the second terminal to the first terminal in response to the short-circuit switch being turned off,
the first terminal of the short-circuit switch is connected to an anode of the diode, and
the second terminal of the short-circuit switch is connected to a cathode of the diode;
a voltage detection circuit that detects a voltage between the anode and the cathode of the diode; and
a control apparatus that turns the short-circuit switch on or off based on a detection value of the voltage detection circuit.

2. The power conversion system according to claim 1, wherein:
the voltage detection circuit is configured to detect an equivalent amount to an effective value of the voltage between the anode and the cathode of the diode, or an equivalent amount to an amplitude of the voltage between the anode and the cathode of the diode; and
the control apparatus
turns off the short-circuit switch in response to the detection value of the voltage detection circuit being determined to be greater than a threshold and
turns on the short-circuit switch in response to the detection value of the voltage detection circuit being determined to be equal to or less than the threshold.

3. The power conversion system according to claim 2, wherein:
the voltage detection circuit is a first voltage detection circuit;
the threshold is a first threshold;
the power conversion system includes a second voltage detection circuit configured to detect an equivalent amount to an effective value of a terminal voltage of the smoothing capacitor or an equivalent amount to an amplitude of the terminal voltage of the smoothing capacitor; and
the control apparatus
turns the short-circuit switch off in response to the detection value of the first voltage detection circuit being determined to be greater than the first threshold and a detection value of the second voltage detection circuit being determined to be greater than a second threshold, and
turns the short-circuit switch on in response to the detection value of the first voltage detection circuit being determined to be equal to or less than the first threshold or the detection value of the second voltage detection circuit being determined to be equal to or less than the second threshold.

4. The power conversion system according to claim 1, wherein:
the control apparatus determines whether a short-circuit failure has occurred in the short-circuit switch based on the detection value of the voltage detection circuit.

5. The power conversion system according to claim 3, further comprising:
a rotating electric machine that is electrically connected to the inverter, wherein:
the control apparatus turns on the short-circuit switch in response to the detection value of the second voltage detection circuit being determined to be greater than an overvoltage threshold during regenerative drive control of the rotating electric machine.

6. The power conversion system according to claim 1, wherein:
the diode is provided on the low-potential-side path; and
the cathode side of the diode is connected to the negative terminal side of the direct-current power supply.

7. The power conversion system according to claim 1, wherein:
the diode is provided on the high-potential-side path; and
the anode side of the diode is connected to the positive terminal side of the direct-current power supply.

8. The power conversion system according to claim 1, wherein:
the at least one inverter comprises a plurality of inverters.

9. A non-transitory computer-readable storage medium storing therein a program applicable to a power conversion system, the power conversion system comprising:
a high-potential-side path that is an electrical path connected to a positive electrode side of a direct-current power supply;
a low-potential-side path that is an electrical path connected to a negative electrode side of the direct-current power supply;
at least one inverter that includes a high-potential-side terminal connected to the high-potential-side path and a low-potential-side terminal connected to the low-potential-side path;
a smoothing capacitor that connects the high-potential-side path and the low-potential-side path;
a diode and a short-circuit switch that is provided on the low-potential-side path or the high-potential-side path; and
a computer, wherein:
the diode is provided to interrupt a flow of current in a prescribed direction from the positive electrode side of the direct-current power supply toward the negative electrode side of the direct-current power supply through the direct-current power supply, in a closed circuit including the direct-current power supply, the high-potential-side path, the low-potential-side path, and the smoothing capacitor;
the short-circuit switch includes a first terminal and a second terminal, and permits a flow of current between the first terminal and the second terminal in response to the short-circuit switch being turned on, and interrupts the a flow of current from the second terminal to the first terminal in response to the short-circuit switch being turned off;
the first terminal of the short-circuit switch is connected to an anode of the diode; and
the second terminal of the short-circuit switch is connected to a cathode of the diode;
the power conversion system includes
a voltage detection circuit configured to detect an equivalent amount to an effective value of a voltage between the anode and the cathode of the diode or an equivalent amount to an amplitude of the voltage between the anode and the cathode of the diode,
when read and executed by the computer, the program causing the computer to implement
a process to turn the short-circuit switch off in response to a detection value of the voltage detection circuit being determined to be greater than a threshold, and
a process to turn the short-circuit switch on in response to the detection value of the voltage detection circuit being determined to be equal to or less than the threshold.
